(19) United States
(12) Patent Application Publication
(10) Pub. No.: US 2026/0088211 A1
(43) Pub. Date: Mar. 26, 2026

(54) MULTILAYER INDUCTOR

(71) Applicant: Murata Manufacturing Co., Ltd., Kyoto-fu (JP)

(72) Inventors: Rika YAMADA, Nagaokakyo-shi (JP); Katsuhisa IMADA, Nagaokakyo-shi (JP)

(73) Assignee: Murata Manufacturing Co., Ltd., Kyoto-fu (JP)

(21) Appl. No.: 19/335,604

(22) Filed: Sep. 22, 2025

(30) Foreign Application Priority Data
Sep. 24, 2024 (JP) 2024-165285

(51) Int. Cl. H01F 27/29; H01F 17/00

(52) U.S. Cl. CPC H01F 27/292; H01F 17/0013; H01F 2017/002

(57) ABSTRACT

A multilayer inductor includes terminal electrodes, a coil conductor, and an extended conductor. The terminal electrodes are on respective end surfaces of a multilayer body and extend onto side surfaces adjoining the end surfaces. The coil conductor is inside the multilayer body and includes loop-segment conductors. The extended conductor is extended from an end portion of the coil conductor and connected to the terminal electrode, and includes outside and inside via-conductors that penetrate through non-conductive layers in the thickness direction thereof to extend parallel to each other. The outside and inside via-conductors are connected, in parallel, to each other and also connected to the terminal electrode at the end surface. As the multilayer body is viewed through in the lamination direction of the non-conductive layers, all parts of the outside via-conductor overlap the loop-segment conductors, and the inside via-conductor is inside an inner periphery of the loop-segment conductors.

### CROSS-REFERENCE TO RELATED APPLICATION

This application claims benefit of priority to Japanese Patent Application No. 2024-165285, filed Sep. 24, 2024, the entire content of which is incorporated herein by reference

### BACKGROUND

### Technical Field

The present disclosure relates to a multilayer inductor in which a coil conductor is disposed inside a multilayer body formed by laminating multiple non-conductive layers made of a non-conductive material, and more particularly, relates to a structure of extension portions extended from the coil conductor to terminal electrodes.

### Background Art

For example, Japanese Unexamined Patent Application Publication No. 2023-148398 discloses a multilayer inductor in the technical field to which the present disclosure pertains. The multilayer inductor includes a multilayer body shaped like a quadrangular prism that has a first end surface and a second end surface that opposes each other and has four side surfaces that connect the first end surface and the second end surface to each other. The multilayer body is formed by laminating multiple non-conductive layers made of a non-conductive material, and the non-conductive layers extend parallel to both first and second end surfaces and are laminated in the direction in which the four side surfaces extend. The multilayer inductor also includes a first terminal electrode disposed at the first end surface and a second terminal electrode disposed at the second end surface. The multilayer inductor further includes a coil conductor disposed inside the multilayer body. The coil conductor includes multiple loop-segment conductors that extend on interfaces between adjacent non-conductive layers so as to form circular segments of the coil conductor and also includes multiple intermediate via-conductors that pierce through non-conductive layers in the thickness direction thereof. The loop-segment conductors are connected to one another using the intermediate via-conductors so as to form the coil conductor that extends along a spiral line. The multilayer inductor further includes a first extended conductor extended from a first end portion of the coil conductor and connected to the first terminal electrode and also includes a second extended conductor extended from a second end portion of the coil conductor, which is positioned opposite to the first end portion, and connected to the second terminal electrode.

The first terminal electrode is formed on the first end surface of the multilayer body so as to extend over part of the side surfaces, the part adjoining the first end surface. The second terminal electrode is formed on the second end surface of the multilayer body so as to extend over part of the side surfaces, the part adjoining the second end surface.

Each of the first extended conductor and the second extended conductor includes multiple via conductors that pierce through non-conductive layers in the thickness direction thereof so as to extend in parallel to each other and that are connected, in parallel, to each other, thereby enabling a large electric current to flow.

### SUMMARY

In the multilayer inductor described above, each of the first extended conductor and the second extended conductor includes multiple via conductors, and each of the first terminal electrode and the second terminal electrode has a side-surface-extension portion that extend over part of the side surfaces. The positional relationship between the via conductors of each extended conductor and the side-surface-extension portion of each terminal electrode is such that the via conductors are disposed so as to extend near the side-surface-extension portion of the terminal electrode while keeping a constant distance between the via conductors and the side-surface-extension portion.

Accordingly, there is a concern that a relatively large stray capacitance may be produced between the via conductors and the side-surface-extension portion of the terminal electrode. Such stray capacitance leads to a deterioration in the high-frequency characteristics of the multilayer inductor.

Accordingly, the present disclosure provides a multilayer inductor that can reduce the stray capacitance produced between the via conductors of the extended conductor and the side-surface-extension portion of the terminal electrode.

According to the present disclosure, a multilayer inductor includes a multilayer body formed by laminating multiple non-conductive layers in a lamination direction. The multilayer body is shaped like a quadrangular prism that has a first end surface and a second end surface opposing each other and has four side surfaces connecting the first end surface and the second end surface to each other. The lamination direction extends parallel to a direction in which the first end surface and the second end surface oppose each other.

The multilayer inductor of the present disclosure further includes a first terminal electrode, a second terminal electrode, and a coil conductor. The first terminal electrode is formed on at least part of the first end surface so as to extend over a part of at least one of the side surfaces, the part adjoining the first end surface. The second terminal electrode is formed on at least part of the second end surface so as to extend over a part of at least one of the side surfaces, the part adjoining the second end surface. The coil conductor is disposed inside the multilayer body.

The coil conductor includes multiple loop-segment conductors and multiple intermediate via-conductors. The loop-segment conductors extend on interfaces between adjacent ones of the non-conductive layers and serve as circular segments of the coil conductor. Each of the intermediate via-conductors penetrates through a non-conductive layer in a thickness direction thereof. The loop-segment conductors are connected to one another by respective ones of the intermediate via-conductors in such a manner that the coil conductor extends along a spiral line.

The multilayer inductor of the present disclosure further includes a first extended conductor and a second extended conductor. The first extended conductor is extended from a first end portion of the coil conductor and connected to the first terminal electrode, and the second extended conductor is extended from a second end portion of the coil conductor and connected to the second terminal electrode, the second end portion being positioned opposite to the first end portion.

In order to address the above technical issue, the multilayer inductor of the present disclosure has the following features.

The first extended conductor includes a first outside via-conductor and a first inside via-conductor that penetrate through non-conductive layers in the thickness direction so as to extend parallel to each other while the first outside via-conductor and the first inside via-conductor are connected, in parallel, to each other and also connected to the first terminal electrode at the first end surface.

The second extended conductor includes a second outside via-conductor and a second inside via-conductor that penetrate through non-conductive layers in the thickness direction so as to extend parallel to each other while the second outside via-conductor and the second inside via-conductor are connected, in parallel, to each other and also connected to the second terminal electrode at the second end surface.

As the multilayer body is viewed through in the lamination direction of the non-conductive layers, all parts of the first outside via-conductor and of the second outside via-conductor are positioned so as to overlap the loop-segment conductors, and at least a part of the first inside via-conductor and at least a part of the second inside via-conductor are positioned inside an inner periphery of the loop-segment conductors.

According to the multilayer inductor of the present disclosure, each extended conductor connected to the terminal electrode includes the via conductors, which are the outside via-conductor and the inside via-conductor. This enables a large electric current to flow in the via conductors.

In addition, as the multilayer body is viewed through in the lamination direction of the non-conductive layers, all parts of the outside via-conductor are positioned so as to overlap the loop-segment conductors, whereas at least part of the inside via-conductor is positioned inside the inner periphery of the loop-segment conductors. The stray capacitance is produced in the structure in which the via conductors of the extended conductor oppose the side-surface-extension portion of the terminal electrode. In the multilayer inductor of the present disclosure, however, the distance from the inside via-conductor to the side-surface-extension portion of the terminal electrode can exceed the distance from the outside via-conductor to the side-surface-extension portion.

Accordingly, the stray capacitance produced between the inside via-conductor and the side-surface-extension portion of the terminal electrode can be made smaller than the stray capacitance produced between the outside via-conductor and the side-surface-extension portion. This can reduce the overall electrostatic capacitance produced in the multilayer inductor and thereby improve the high-frequency characteristics of the multilayer inductor.

### BRIEF DESCRIPTION OF THE DRAWINGS

FIG. 1 is a perspective view illustrating the external appearance of a multilayer inductor according to a first embodiment of the present disclosure;

FIG. 2 is a plan view illustrating non-conductive layers each of which includes a segment of a first extended conductor and a segment of a coil conductor, the first extended conductor and the coil conductor being included in the multilayer inductor of FIG. 1;

FIG. 3 is a plan view illustrating non-conductive layers each of which includes a segment of the coil conductor and a segment of a second extended conductor, the coil conductor and the second extended conductor being included in the multilayer inductor of FIG. 1;

FIG. 4 is an enlarged cross-sectional view illustrating part of the multilayer inductor of FIG. 1, the cross-sectional view being taken along line A-A in view (1) of FIG. 2;

FIG. 5 is a view illustrating a first outside via-conductor and a first inside via-conductor for explaining a distinctive structure of the multilayer inductor of FIG. 1, the first outside via-conductor and the first inside via-conductor being viewed through a multilayer body in the lamination direction of the non-conductive layers;

FIG. 6 is a view illustrating a multilayer inductor according to a second embodiment of the present disclosure, the view corresponding to FIG. 5;

FIG. 7 is a view illustrating a multilayer inductor according to a third embodiment of the present disclosure, the view corresponding to FIG. 5;

FIG. 8 is a view illustrating a multilayer inductor according to a fourth embodiment of the present disclosure, the view corresponding to FIG. 5; and

FIG. 9 is a side view illustrating a multilayer inductor according to a fifth embodiment of the present disclosure.

### DETAILED DESCRIPTION

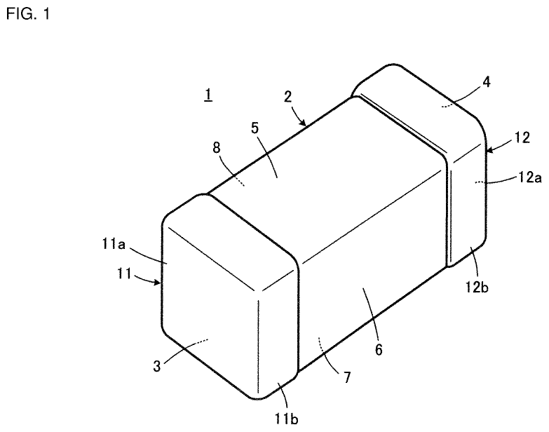

A multilayer inductor 1 according to a first embodiment of the present disclosure will be described with reference to FIGS. 1 to 5.

As illustrated in FIG. 1, the multilayer inductor 1 includes a multilayer body 2, which serves as the main body of the multilayer inductor 1. The multilayer body 2 is shaped like a quadrangular prism that has a first end surface 3 and a second end surface 4 that oppose each other and has four side surfaces 5 to 8 that connect the first end surface 3 and the second end surface 4 to each other. The multilayer body 2 may be shaped substantially like a quadrangular prism with edges and vertices being rounded or chamfered.

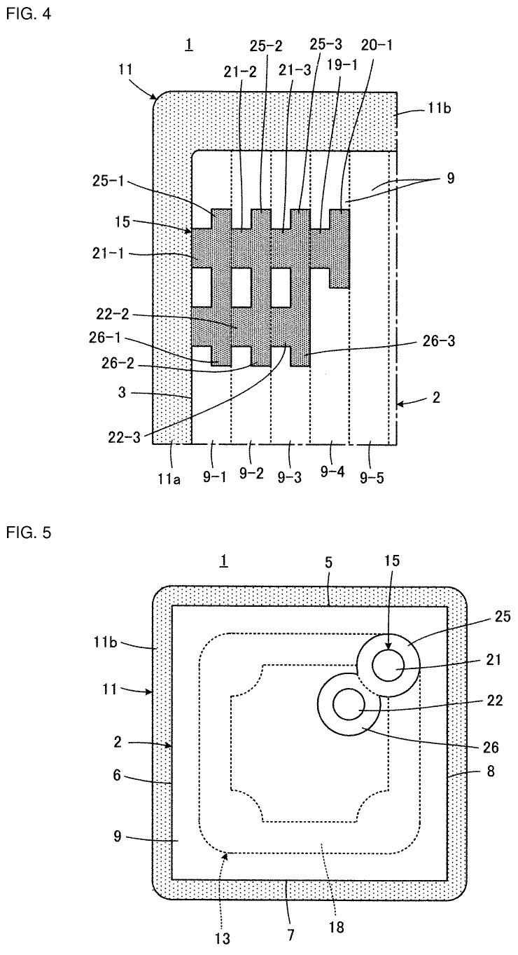

The multilayer body 2 has a multilayer structure in which multiple non-conductive layers 9 (see FIG. 4) are laminated. Each of the non-conductive layers 9 extends parallel to both of the first end surface 3 and the second end surface 4. The non-conductive layers 9 are laminated in the direction of the side surfaces 5 to 8 extending. In other words, the non-conductive layers 9 are laminated from the first end surface 3 toward the second end surface 4. The principal surfaces of the non-conductive layers 9 positioned at opposite ends in the lamination direction serve as the first end surface 3 and the second end surface 4 of the multilayer body 2, respectively.

Each non-conductive layer 9 is made of a non-conductive material containing, for example, at least one of glass, resin, and ferrite. In a case of the non-conductive layer 9 being made of a resin-molded body or the like, the non-conductive layer 9 may contain a non-magnetic filler such as silica or a magnetic filler such as ferrite or magnetic metal. The non-conductive layer 9 may be made of a material containing two or more of glass, resin, and ferrite.

A first terminal electrode 11 and a second terminal electrode 12 are formed on outer surfaces of the multilayer body 2. The first terminal electrode 11 is formed on the first end surface 3 and also on part of the side surfaces 5 to 8 of the multilayer body 2, the part adjoining the first end surface 3. In other words, the first terminal electrode 11 includes an end-surface portion 11a formed on the first end surface 3 and a side-surface-extension portion 11b formed on the side surfaces 5 to 8. Similarly, the second terminal electrode 12 is formed on the second end surface 4 and also on part of the side surfaces 5 to 8, the part adjoining the second end surface 4. In other words, the second terminal electrode 12 includes an end-surface portion 12a formed on the second end surface 4 and a side-surface-extension portion 12b formed on the side surfaces 5 to 8. The multilayer inductor 1 configured as above is mounted on a circuit board with any one of the side surfaces 5 to 8 serving as a mounting surface.

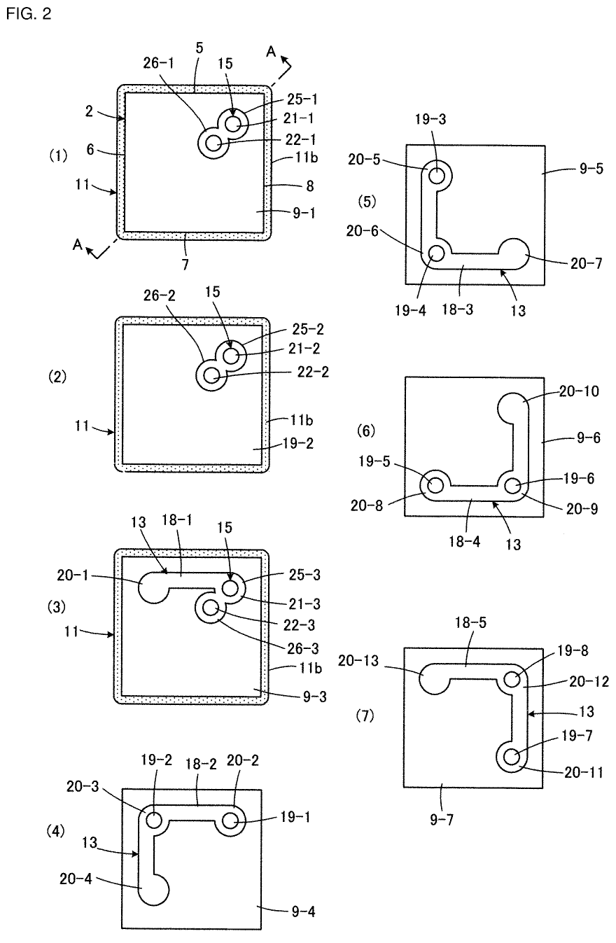

As illustrated in FIGS. 2 to 5, a coil conductor 13 and a first extended conductor 15 and a second extended conductor 16 are disposed inside the multilayer body 2. The coil conductor 13 extends along a spiral line with the axis of the spiral line extending in the direction in which the first end surface 3 and the second end surface 4 opposes.

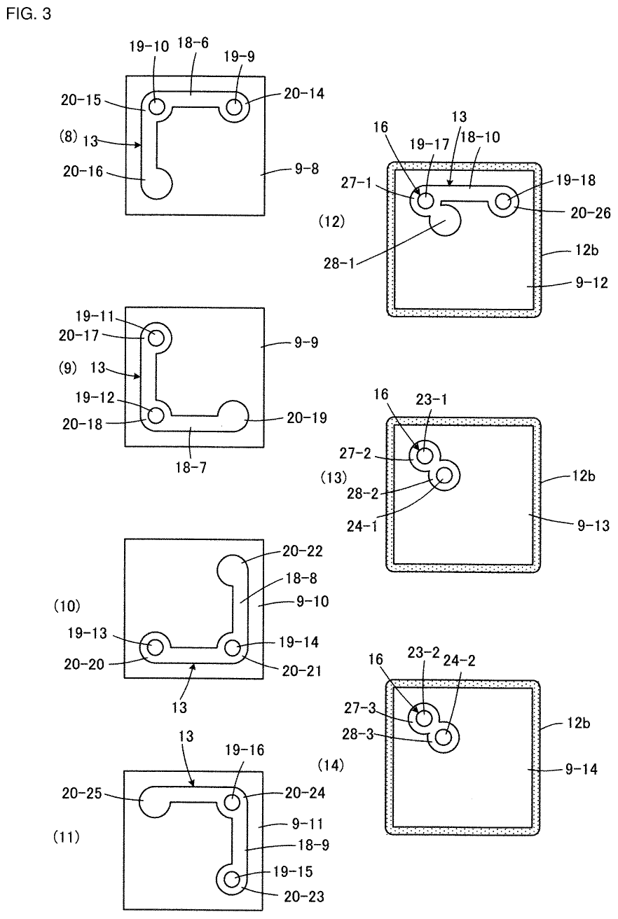

FIGS. 2 and 3 illustrate the non-conductive layers 9 each of which includes a segment of the coil conductor 13 and a segment of the first extended conductor 15 or of the second extended conductor 16. In FIGS. 2 and 3, reference numbers (1) to (14) are views (1) to (14) which indicate the lamination order starting from the first end surface 3 to the second end surface 4 of the multilayer body 2.

The coil conductor 13 includes multiple loop-segment conductors 18 and multiple intermediate via-conductors 19. The loop-segment conductors 18 extend on respective interfaces between adjacent non-conductive layers 9 so as to form circular segments of the coil conductor 13. The intermediate via-conductors 19 penetrate through respective non-conductive layers 9 in the thickness direction. The loop-segment conductors 18 are connected to one another using the intermediate via-conductors 19 to form the coil conductor 13 that extends along the spiral line. Further details will be described later.

In the following description, when it is necessary to distinguish multiple non-conductive layers 9, multiple loop-segment conductors 18, and multiple intermediate via-conductors 19, a subclass number, such as “−1”, “−2”, or “−3”, is added to the reference number indicating the non-conductive layer, the loop-segment conductor, or the intermediate via-conductor.

The first extended conductor 15 includes a first outside via-conductor 21 and a first inside via-conductor 22. The first outside via-conductor 21 and the first inside via-conductor 22 penetrate through non-conductive layers 9 in the thickness direction, extend parallel to each other, and are connected, in parallel, to each other. The first outside via-conductor 21 and the first inside via-conductor 22 are connected to the first terminal electrode 11 at the first end surface 3. The second extended conductor 16 includes a second outside via-conductor 23 and a second inside via-conductor 24. The second outside via-conductor 23 and the second inside via-conductor 24 penetrate through non-conductive layers 9 in the thickness direction, extend parallel to each other, and are connected, in parallel, to each other. The second outside via-conductor 23 and the second inside via-conductor 24 are connected to the second terminal electrode 12 at the second end surface 4.

In the following description, when it is necessary to distinguish multiple segments of the first outside via-conductor 21, of the first inside via-conductor 22, of the second outside via-conductor 23, and of the second inside via-conductor 24, a subclass number, such as “−1”, “−2”, or “−3”, is added to the reference number indicating the first outside via-conductor, the first inside via-conductor, the second outside via-conductor, or the second inside via-conductor.

The first outside via-conductor 21, the first inside via-conductor 22, the second outside via-conductor 23, and the second inside via-conductor 24 extend so as to penetrate through multiple non-conductive layers 9 in the thickness direction. First outside land-conductors 25 are formed on respective interfaces between adjacent non-conductive layers 9 so as to extend from the first outside via-conductor 21. First inside land-conductors 26 are formed on respective interfaces between adjacent non-conductive layers 9 so as to extend from the first inside via-conductor 22. Second outside land-conductors 27 are formed on respective interfaces between adjacent non-conductive layers 9 so as to extend from the second outside via-conductor 23, and second inside land-conductors 28 are formed on respective interfaces between adjacent non-conductive layers 9 so as to extend from the second inside via-conductor 24.

In the following description, it is necessary to distinguish multiple first outside land-conductors 25, multiple first inside land-conductors 26, multiple second outside land-conductors 27, and multiple second inside land conductors 28. In such cases, a subclass number, such as “−1”, “−2”, or “−3”, is added to the reference number indicating the first outside land-conductor, the first inside land-conductor, the second outside land-conductor, or the second inside land-conductor.

The following describes the coil conductor 13 and the extended conductors 15 and 16 and others in detail with reference to FIGS. 2 to 4.

As illustrated in view (1) of FIG. 2, a first outside land-conductor 25-1 and a first inside land-conductor 26-1 are disposed in a non-conductive layer 9-1. A first outside via-conductor 21-1 and a first inside via-conductor 22-1 are disposed so as to overlap the first outside land-conductor 25-1 and the first inside land-conductor 26-1, respectively. The first outside via-conductor 21-1 and the first inside via-conductor 22-1 form part of the first extended conductor 15. The first outside via-conductor 21-1 and the first inside via-conductor 22-1 are connected to the end-surface portion 11a of the first terminal electrode 11 as illustrated clearly in FIG. 4.

Note that the positions of the first outside land-conductor 25-1 and the first inside land-conductor 26-1 relative to the non-conductive layer 9-1 are different between FIG. 4 and view (1) in FIG. 2. More specifically, the first outside land-conductor 25-1 and the first inside land-conductor 26-1 are buried in the non-conductive layer 9-1 as illustrated in FIG. 4 and accordingly not supposed to appear in view (1) in FIG. 2. View (1) in FIG. 2, however, illustrates the first outside land-conductor 25-1 and the first inside land-conductor 26-1, as if these were viewed through the non-conductive layer 9-1, in order to indicate the shapes and positions of these elements clearly. Note that the same illustration method is adopted in views (2) to (7) in FIG. 2 and also views (8) to (13) in FIG. 3.

Next, as illustrated in view (2) in FIG. 2, a first outside land-conductor 25-2 and a first inside land-conductor 26-2 are disposed in a non-conductive layer 9-2, which is positioned below the non-conductive layer 9-1 (according to the illustrated example). A first outside via-conductor 21-2 and a first inside via-conductor 22-2 are disposed so as to overlap the first outside land-conductor 25-2 and the first inside land-conductor 26-2, respectively. The first outside via-conductor 21-2 and the first inside via-conductor 22-2 form part of the first extended conductor 15. As illustrated clearly in FIG. 4, the first outside via-conductor 21-2 and the first inside via-conductor 22-2 are connected to the first outside land-conductor 25-1 above and the first inside land-conductor 26-1 above, respectively.

Next, as illustrated in view (3) in FIG. 2, a first outside land-conductor 25-3 and a first inside land-conductor 26-3 are disposed in a non-conductive layer 9-3, which is positioned below the non-conductive layer 9-2. A first outside via-conductor 21-3 and a first inside via-conductor 22-3 are disposed so as to overlap the first outside land-conductor 25-3 and the first inside land-conductor 26-3, respectively. The first outside via-conductor 21-3 and the first inside via-conductor 22-3 form part of the first extended conductor 15. As illustrated clearly in FIG. 4, the first outside via-conductor 21-3 and the first inside via-conductor 22-3 are connected to the first outside land-conductor 25-2 above and the first inside land-conductor 26-2 above, respectively. In addition, a loop-segment conductor 18-1 is disposed in the non-conductive layer 9-3 so as to extend from the first outside land-conductor 25-3. The loop-segment conductor 18-1 form part of the coil conductor 13. The loop-segment conductor 18-1 is shaped like the letter “I”, and an intermediate pad 20-1 having a larger area is formed at the end. In the present disclosure, the loop-segment conductors 18 include intermediate pads 20.

As illustrated in views (1) to (3) of FIG. 2, the side-surface-extension portion 11b of the first terminal electrode 11 is formed so as to surround the non-conductive layers 9-1 to 9-3.

Next, as illustrated in view (4) in FIG. 2, a loop-segment conductor 18-2 that forms part of the coil conductor 13 is disposed in a non-conductive layer 9-4, which is positioned below the non-conductive layer 9-3. The loop-segment conductor 18-2 is shaped like the letter “L”. Intermediate pads 20-2, 20-3, and 20-4 each having a larger area are formed at one end, the bent portion, and the other end of the loop-segment conductor 18-2, respectively. An intermediate via-conductor 19-1 is disposed so as to overlap the intermediate pad 20-2, and an intermediate via-conductor 19-2 is disposed so as to overlap the intermediate pad 20-3. As illustrated clearly in FIG. 4, the intermediate via-conductor 19-1 is connected to the first outside land-conductor 25-3 above. The intermediate via-conductor 19-2 is connected to the intermediate pad 20-1 above. A part of the loop-segment conductor 18-2 is connected, in parallel, to the loop-segment conductor 18-1. This structure enables a large current to flow through the coil conductor 13, and the same configuration is adopted in the loop-segment conductors described below.

Next, as illustrated in view (5) in FIG. 2, a loop-segment conductor 18-3 that forms part of the coil conductor 13 is disposed in a non-conductive layer 9-5, which is positioned below the non-conductive layer 9-4. The loop-segment conductor 18-3 is shaped like the letter “L”. Intermediate pads 20-5, 20-6, and 20-7 each having a larger area are formed at one end, the bent portion, and the other end of the loop-segment conductor 18-3, respectively. An intermediate via-conductor 19-3 is disposed so as to overlap the intermediate pad 20-5, and an intermediate via-conductor 19-4 is disposed so as to overlap the intermediate pad 20-6. The intermediate via-conductor 19-3 is connected to the intermediate pad 20-3 above, and the intermediate via-conductor 19-4 is connected to the intermediate pad 20-4 above. A part of the loop-segment conductor 18-3 is connected, in parallel, to a part of the loop-segment conductor 18-2.

Next, as illustrated in view (6) in FIG. 2, a loop-segment conductor 18-4 that forms part of the coil conductor 13 is disposed in a non-conductive layer 9-6, which is positioned below the non-conductive layer 9-5. The loop-segment conductor 18-4 is shaped like the letter “L”. Intermediate pads 20-8, 20-9, and 20-10 each having a larger area are formed at one end, the bent portion, and the other end of the loop-segment conductor 18-4, respectively. An intermediate via-conductor 19-5 is disposed so as to overlap the intermediate pad 20-8, and an intermediate via-conductor 19-6 is disposed so as to overlap the intermediate pad 20-9. The intermediate via-conductor 19-5 is connected to the intermediate pad 20-6 above, and the intermediate via-conductor 19-6 is connected to the intermediate pad 20-7 above. A part of the loop-segment conductor 18-4 is connected, in parallel, to a part of the loop-segment conductor 18-3.

Next, as illustrated in view (7) in FIG. 2, a loop-segment conductor 18-5 that forms part of the coil conductor 13 is disposed in a non-conductive layer 9-7, which is positioned below the non-conductive layer 9-6. The loop-segment conductor 18-5 is shaped like the letter “L”. Intermediate pads 20-11, 20-12, and 20-13 each having a larger area are formed at one end, the bent portion, and the other end of the loop-segment conductor 18-5, respectively. An intermediate via-conductor 19-7 is disposed so as to overlap the intermediate pad 20-11, and an intermediate via-conductor 19-8 is disposed so as to overlap the intermediate pad 20-12. The intermediate via-conductor 19-7 is connected to the intermediate pad 20-9 above, and the intermediate via-conductor 19-8 is connected to the intermediate pad 20-10 above. A part of the loop-segment conductor 18-5 is connected, in parallel, to a part of the loop-segment conductor 18-4.

Next, as illustrated in view (8) in FIG. 3, a loop-segment conductor 18-6 that forms part of the coil conductor 13 is disposed in a non-conductive layer 9-8, which is positioned below the non-conductive layer 9-7. The loop-segment conductor 18-6 is shaped like the letter “L”. Intermediate pads 20-14, 20-15, and 20-16 each having a larger area are formed at one end, the bent portion, and the other end of the loop-segment conductor 18-6, respectively. An intermediate via-conductor 19-9 is disposed so as to overlap the intermediate pad 20-14, and an intermediate via-conductor 19-10 is disposed so as to overlap the intermediate pad 20-15. The intermediate via-conductor 19-9 is connected to the intermediate pad 20-12 above, and the intermediate via-conductor 19-10 is connected to the intermediate pad 20-13 above. A part of the loop-segment conductor 18-6 is connected, in parallel, to a part of the loop-segment conductor 18-5.

Next, as illustrated in view (9) in FIG. 3, a loop-segment conductor 18-7 that forms part of the coil conductor 13 is disposed in a non-conductive layer 9-9, which is positioned below the non-conductive layer 9-8. The loop-segment conductor 18-7 is shaped like the letter “L”. Intermediate pads 20-17, 20-18, and 20-19 each having a larger area are formed at one end, the bent portion, and the other end of the loop-segment conductor 18-7, respectively. An intermediate via-conductor 19-11 is disposed so as to overlap the intermediate pad 20-17, and an intermediate via-conductor 19-12 is disposed so as to overlap the intermediate pad 20-18. The intermediate via-conductor 19-11 is connected to the intermediate pad 20-15 above, and the intermediate via-conductor 19-12 is connected to the intermediate pad 20-16 above. A part of the loop-segment conductor 18-7 is connected, in parallel, to a part of the loop-segment conductor 18-6.

Next, as illustrated in view (1) in FIG. 3, a loop-segment conductor 18-8 that forms part of the coil conductor 13 is disposed in a non-conductive layer 9-10, which is positioned below the non-conductive layer 9-9. The loop-segment conductor 18-8 is shaped like the letter “L”. Intermediate pads 20-20, 20-21, and 20-22 each having a larger area are formed at one end, the bent portion, and the other end of the loop-segment conductor 18-8, respectively. An intermediate via-conductor 19-13 is disposed so as to overlap the intermediate pad 20-20, and an intermediate via-conductor 19-14 is disposed so as to overlap the intermediate pad 20-21. The intermediate via-conductor 19-13 is connected to the intermediate pad 20-18 above, and the intermediate via-conductor 19-14 is connected to the intermediate pad 20-19 above. A part of the loop-segment conductor 18-8 is connected, in parallel, to a part of the loop-segment conductor 18-7.

Next, as illustrated in view (11) in FIG. 3, a loop-segment conductor 18-9 that forms part of the coil conductor 13 is disposed in a non-conductive layer 9-11, which is positioned below the non-conductive layer 9-10. The loop-segment conductor 18-9 is shaped like the letter “L”. Intermediate pads 20-23, 20-24, and 20-25 each having a larger area are formed at one end, the bent portion, and the other end of the loop-segment conductor 18-9, respectively. An intermediate via-conductor 19-15 is disposed so as to overlap the intermediate pad 20-24, and an intermediate via-conductor 19-16 is disposed so as to overlap the intermediate pad 20-25. The intermediate via-conductor 19-15 is connected to the intermediate pad 20-21 above, and the intermediate via-conductor 19-16 is connected to the intermediate pad 20-22 above. A part of the loop-segment conductor 18-9 is connected, in parallel, to a part of the loop-segment conductor 18-8.

Next, as illustrated in view (12) in FIG. 3, a second outside land-conductor 27-1 and a second inside land-conductor 28-1 are disposed in a non-conductive layer 9-12, which is positioned below the non-conductive layer 9-11. An intermediate via-conductor 19-17 is disposed so as to overlap the second outside land-conductor 27-1. The intermediate via-conductor 19-17 is connected to the intermediate pad 20-25 above. A loop-segment conductor 18-10 that forms part of the coil conductor 13 is disposed in a non-conductive layer 9-12 so as to extend from the second outside land-conductor 27-1. The loop-segment conductor 18-10 is shaped like the letter “I”, and an intermediate pad 20-26 having a larger area is formed at the end thereof. An intermediate via-conductor 19-18 is disposed so as to overlap the intermediate pad 20-26. The intermediate via-conductor 19-18 is connected to the intermediate pad 20-24 above. The loop-segment conductor 18-10 is connected, in parallel, to a part of the loop-segment conductor 18-9.

Next, as illustrated in view (13) in FIG. 3, a second outside land-conductor 27-2 and a second inside land-conductor 28-2 are disposed in a non-conductive layer 9-13, which is positioned below the non-conductive layer 9-12. A second outside via-conductor 23-1 and a second inside via-conductor 24-1 are disposed so as to overlap the second outside land-conductor 27-2 and the second inside land-conductor 28-2, respectively. The second outside via-conductor 23-1 and the second inside via-conductor 24-1 form part of the second extended conductor 16. The second outside via-conductor 23-1 and the second inside via-conductor 24-1 are connected to the second outside land-conductor 27-1 above and the second inside land-conductor 28-1 above, respectively.

As illustrated in view (14) in FIG. 3, a second outside land-conductor 27-3 and a second inside land-conductor 28-3 are disposed in a non-conductive layer 9-14, which is positioned below the non-conductive layer 9-13. A second outside via-conductor 23-2 and a second inside via-conductor 24-2 are disposed so as to overlap the second outside land-conductor 27-3 and the second inside land-conductor 28-3, respectively. The second outside via-conductor 23-2 and the second inside via-conductor 24-2 form part of the second extended conductor 16. The second outside via-conductor 23-2 and the second inside via-conductor 24-2 are connected to the second outside land-conductor 27-2 above and the second inside land-conductor 28-2 above, respectively. The second outside via-conductor 23-2 and the second inside via-conductor 24-2 are also connected to the end-surface portion 12b of the second terminal electrode 12.

As illustrated in views (12) to (14) in FIG. 3, a side-surface-extension portion 12b of the second terminal electrode 12 is formed so as to surround the non-conductive layers 9-12 to 9-14.

Next, the positional features of the outside via-conductor 21 and the inside via-conductor 22 of the first extended conductor 15 is described with reference to FIG. 5. Although FIG. 5 illustrates the first outside via-conductor 21 and the first inside via-conductor 22 of the first extended conductor 15, the second outside via-conductor 23 and the second inside via-conductor 24 of the second extended conductor 16 have substantially the same structure. Accordingly, the descriptions of the second outside via-conductor 23 and the second inside via-conductor 24 will be omitted, while the “first end surface”, the “first terminal electrode”, the “first extended conductor”, the “first outside via-conductor”, and the “first inside via-conductor”, for example, are referred to simply as the “end surface”, the “terminal electrode”, the “extended conductor”, the “outside via-conductor”, and the “inside via-conductor”, respectively.

FIG. 5 illustrates the coil conductor 13 having the loop-segment conductors 18, which is indicated by the dotted line, as the multilayer body 2 is viewed through in the lamination direction of the non-conductive layers 9. As described above, the extended conductor 15 includes the outside via-conductor 21 and the inside via-conductor 22 that penetrate through non-conductive layers 9 in the thickness direction so as to extend parallel to each other, and the outside via-conductor 21 and the inside via-conductor 22 are connected to the terminal electrode 11 at the end surface 3.

As illustrated in FIG. 5, all parts of the outside via-conductor 21 overlap the loop-segment conductors 18, whereas at least a part of the inside via-conductor 22 is positioned inside the inner periphery of the loop-segment conductors 18. Due to the inside via-conductor 22 being positioned in this manner, the distance from the inside via-conductor 22 to the side-surface-extension portion 11b of the terminal electrode 11 can exceed the distance from the outside via-conductor 21 to the side-surface-extension portion 11b. As a result, the stray capacitance produced between the inside via-conductor 22 and the side-surface-extension portion 11b of the terminal electrode 11 can be made smaller than the stray capacitance produce between the outside via-conductor 21 and the side-surface-extension portion 11b. This can reduce the overall capacitance produced in the multilayer inductor 1 and thereby shift a resonance point in impedance toward the high-frequency side, which can improve the noise reduction effect of the multilayer inductor 1 in a high-frequency range.

In this embodiment, all parts of the inside via-conductor 22 are positioned inside the inner periphery of the loop-segment conductors 18. This can further increase the distance between the inside via-conductor 22 and the side-surface-extension portion 11b of the terminal electrode 11, which can contribute to a further reduction in the stray capacitance.

Moreover, in this embodiment, the loop-segment conductors 18 extend so as to follow a substantially rectangular shape, for example, having four corners. The outside via-conductor 21 is positioned so as to overlap a corner portion of the loop-segment conductors 18. This leads to a reliable connection between the outside via-conductor 21 and the loop-segment conductors 18 even if the position of the outside via-conductor 21 is shifted unintentionally during the manufacture of the multilayer inductor 1, which can reduce the risk of disconnection.

In addition, in this embodiment, the multilayer inductor 1 includes the outside land-conductors 25 extending from the outside via-conductor 21 and the inside land-conductors 26 extending from the inside via-conductor 22, and each outside land-conductor 25 and the corresponding inside land-conductor 26 are integrated into one piece. This can simplify the process of printing the outside land-conductors 25 and the inside land-conductors 26 and also can avoid the trouble caused by disconnection. Put another way, assume that the outside land-conductor 25 and the inside land-conductor 26 are not integrated. In this case, if the disconnection occurs due to, for example, an absence of a segment of the outside via-conductor 21 or the inside via-conductor 22, both of which extend in the lamination direction, an electric current, which does not flow at the absent segment, concentrates in the via conductor having no absence of the segment, which may lead to unexpected heat generation. Due to the outside land-conductor 25 and the inside land-conductor 26 being formed integrally, the trouble caused by disconnection can be avoided.

In this embodiment, the outline of the outside land-conductor 25 and the inside land-conductor 26 formed integrally is shaped such that an imaginary outside circle having the center positioned at the outside via-conductor 21 partially superposes an imaginary inside circle having the center positioned at the inside via-conductor 22. According to this configuration, the area encompassed by the outline of the outside land-conductor 25 and the inside land-conductor 26 can be made small compared with a case of a single land conductor of which the outline is a large circle that encompasses both of the outside via-conductor 21 and the inside via-conductor 22. This can reduce the area of a cross-section that blocks magnetic flux passing inside the inner periphery of the coil conductor 13, which can control a reduction in impedance caused by the blockage of magnetic flux.

The following describes an example method of manufacturing the multilayer inductor 1 described above.

A green sheet for non-conductive layers 9 is prepared. The green sheet is obtained by molding slurry into a sheet, the slurry containing a magnetic material powder, an organic binder, an organic solvent, and a plasticizer. A non-magnetic material powder, such as a borosilicate glass powder, may be used in place of the magnetic material powder.

Meanwhile, a conductive paste containing a silver powder or the like is prepared.

The land conductors 25 to 28 are printed by applying the conductive paste onto a first portion of the green sheet where the extended conductor 15 and the extended conductor 16 are to be formed. The via conductors 21 to 24 are subsequently formed in the first portion. In order to compensate the thicknesses of the land conductors 25 to 28 and via conductors 21 to 24 and to obtain a constant thickness of the green sheet, the slurry is subsequently applied onto the green sheet where the land conductors 25 to 28 and the via conductors 21 to 24 are not present.

On the other hand, in a portion (a second portion) of the green sheet where the coil conductor 13 is to be formed, the loop-segment conductors 18 and the intermediate via-conductors 19 are printed onto the green sheet by applying the conductive paste. The slurry is subsequently applied onto the green sheet where the loop-segment conductors 18 and the intermediate via-conductors 19 are not present. The second portion where the coil conductor 13 is positioned is obtained by repeating the above process.

Next, the first portions and the second portion are stacked such that the first portions sandwiches the second portion. The first portions and the second portion are pressure-bonded in the lamination direction and cut into pieces each having predetermined dimensions to obtain green multilayer bodies 2.

The green multilayer body 2 are sintered and, if necessary, barrel-polished. The terminal electrodes 11 and 12 are formed on each multilayer body 2. The terminal electrodes 11 and 12 are formed by sintering the conductive paste. If necessary, nickel plating and tin plating, for example, are performed thereon.

The multilayer inductor 1 is thus obtained. In an actual multilayer inductor 1, the interfaces between adjacent non-conductive layers cannot be recognized in most cases.

Note that in forming the via conductor 19 or the via conductors 21 to 24, predetermined portions of the green sheet may be irradiated with a laser beam to form holes, and the holes may be filled with the conductive paste. In this case, the filling of the conductive paste may be performed when the loop-segment conductors 18 and the land conductors 25 to 28 are printed using the conductive paste.

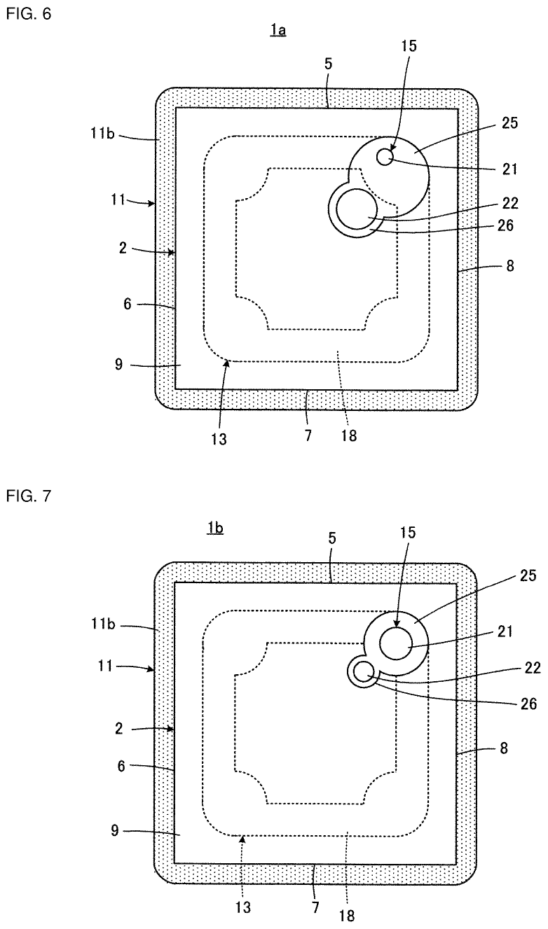

FIG. 6 is a view illustrating a multilayer inductor 1a according to a second embodiment of the present disclosure, the view corresponding to FIG. 5. In FIG. 6, the elements corresponding to those illustrated in FIG. 5 will be denoted by the same reference signs, and duplicated descriptions will be omitted.

In the embodiment illustrated in FIG. 6, the cross-sectional area of the outside via-conductor 21 is smaller and the cross-sectional area of the inside via-conductor 22 is larger compared with those in the embodiment illustrated in FIG. 5. The total cross-sectional area of the outside via-conductor 21 and the inside via-conductor 22 remains the same in both embodiments of FIG. 6 and FIG. 5. Accordingly, the density of the electric current flowing through the extended conductor 15 remains the same.

According to the embodiment of FIG. 6, the stray capacitance produced between the outside via-conductor 21 and the side-surface-extension portion 11b of the terminal electrode 11 can be reduced compared with the case of the embodiment of FIG. 5. Accordingly, this can shift a resonance point in impedance further toward the high-frequency side, which can further improve the noise reduction effect of the multilayer inductor 1 in a high-frequency range.

In addition, in the embodiment of FIG. 6, the outline of the outside land-conductor 25 and the inside land-conductor 26 formed integrally is shaped such that the imaginary outside circle having the center positioned at the outside via-conductor 21 partially superposes the imaginary inside circle having the center positioned at the inside via-conductor 22, as is the case in the embodiment of FIG. 5. In this case, however, the inside circle is smaller than the outside circle. This can further reduce the area of the section that blocks the magnetic flux passing inside the inner periphery of the coil conductor 13 compared with the case of the embodiment of FIG. 5, which can further control a reduction in impedance caused by the blockage of magnetic flux.

FIG. 7 is a view illustrating a multilayer inductor 1b according to a third embodiment of the present disclosure, the view corresponding to FIG. 5. In FIG. 7, the elements corresponding to those illustrated in FIG. 5 will be denoted by the same reference signs, and duplicated descriptions will be omitted.

In the embodiment illustrated in FIG. 7, the cross-sectional area of the inside via-conductor 22 is smaller than those in the embodiments illustrated in FIGS. 5 and 6.

According to this configuration, the stray capacitance produced between the inside via-conductor 22 and the side-surface-extension portion 11b of the terminal electrode 11 can be reduced compared with the cases of the embodiments of FIGS. 5 and 6.

In addition, the outline of the outside land-conductor 25 and the inside land-conductor 26 formed integrally is shaped such that the imaginary outside circle having the center positioned at the outside via-conductor 21 partially superposes the imaginary inside circle having the center positioned at the inside via-conductor 22. In this case, however, the inside circle is smaller than the outside circle.

This can further reduce the area of the section that blocks the magnetic flux passing inside the inner periphery of the coil conductor 13 compared with the cases of the embodiments of FIGS. 5 and 6, which can further control a reduction in impedance caused by the blockage of magnetic flux.

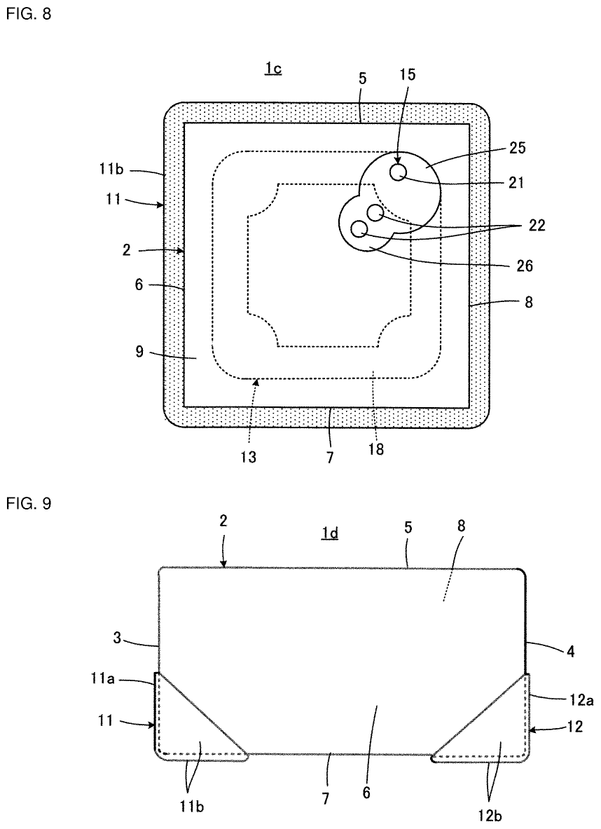

FIG. 8 is a view illustrating a multilayer inductor 1c according to a fourth embodiment of the present disclosure, the view corresponding to FIG. 5. In FIG. 8, the elements corresponding to those illustrated in FIG. 5 will be denoted by the same reference signs, and duplicated descriptions will be omitted.

In the embodiment illustrated in FIG. 8, the cross-sectional area of the inside via-conductor 22 is smaller compared with that in the embodiment illustrated in FIG. 5. The inside via-conductor 22 is provided at multiple locations, for example, at two locations.

According to this configuration, the stray capacitance produced between the inside via-conductor 22 and the side-surface-extension portion 11b of the terminal electrode 11 can be reduced compared with the case of the embodiment of FIG. 5.

In addition, in the embodiment of FIG. 8, the cross-sectional area of the outside via-conductor 21 is further reduced as is the case in the embodiment of FIG. 6. Accordingly, the stray capacitance produced between the outside via-conductor 21 and the side-surface-extension portion 11b of the terminal electrode 11 can be reduced compared with the case of the embodiment of FIG. 5.

FIG. 9 is a side view illustrating the external appearance of a multilayer inductor 1d according to a fifth embodiment of the present disclosure. In FIG. 9, the elements corresponding to those illustrated in FIG. 1 will be denoted by the same reference signs, and duplicated descriptions will be omitted.

In the embodiment illustrated in FIG. 9, the first terminal electrode 11 and the second terminal electrode 12 have distinctive shapes. More specifically, the first terminal electrode 11 and the second terminal electrode 12 have the end-surface portions 11a and 12a that cover part of the first end surface 3 and part of the second end surface 4 of the multilayer body 2, respectively. In addition, the first terminal electrode 11 and the second terminal electrode 12 have respective side-surface-extension portions 11b and 12b that partially cover the side surface 7 and do not cover the side surface 5. The side-surface-extension portions 11b and 12b are each shaped triangularly on each of the side surfaces 6 and 8. In this embodiment, the multilayer inductor 1d is mounted on a circuit board with the side surface 7 serving as a mounting surface.

Even in the embodiment of FIG. 9, the stray capacitance still occurs between the via conductor of the extended conductor and the side-surface-extension portion 11b of the first terminal electrode 11 and between the via conductor of the extended conductor and the side-surface-extension portion 12b of the second terminal electrode 12. Accordingly, it is useful to adopt the above described features of the present disclosure.

The present disclosure has been described with reference to some illustrated embodiments. However, other variations are conceivable within the scope of the present disclosure.

For example, the length of the extended conductor can be changed arbitrarily by changing the number of the non-conductive layers laminated so as to increase or decrease the number of the segments of the outside via-conductor and of the inside via-conductor.

The number of turns of the coil conductor 13 can be changed arbitrarily by changing the number of non-conductive layers laminated. More specifically, the number of turns of the coil conductor 13 can be increased by increasing the number of sets of the lamination structures illustrated in views (4) to (7) in FIG. 2 or can be decreased by decreasing the number of sets of the lamination structures illustrated in views (4) to (7) in FIG. 2. Alternatively, the number of turns can be changed by changing the shape of each loop-segment conductor that forms the coil conductor 13.

In the illustrated embodiments, adjacent loop-segment conductors of the coil conductor 13 include the portions that extend parallel to each other and are connected, in parallel, to each other, thereby enabling a large electric current to flow. The adjacent loop-segment conductors, however, do not need to be connected in parallel.

The embodiments described herein are examples, and the configurations described in different embodiments can be replaced partially, or combined, with one another.

The following are modes of implementing the present disclosure.

<1> A multilayer inductor includes a multilayer body including multiple non-conductive layers laminated in a lamination direction, the multilayer body being shaped like a quadrangular prism that has a first end surface and a second end surface opposing each other and has four side surfaces connecting the first end surface and the second end surface to each other, the lamination direction extending parallel to a direction in which the first end surface and the second end surface face oppose each other. The multilayer inductor further includes a first terminal electrode formed on at least part of the first end surface so as to extend over a part of at least one of the side surfaces, the part adjoining the first end surface. The multilayer inductor further includes a second terminal electrode formed on at least part of the second end surface so as to extend over a part of at least one of the side surfaces, the part adjoining the second end surface. The multilayer inductor further includes a coil conductor disposed inside the multilayer body. The coil conductor includes multiple loop-segment conductors that extend on interfaces between adjacent ones of the non-conductive layers and serve as circular segments of the coil conductor. The coil conductor also includes multiple intermediate via-conductors each of which penetrates through a non-conductive layer in a thickness direction thereof. The loop-segment conductors being connected to one another by respective ones of the intermediate via-conductors in such a manner that the coil conductor extends along a spiral line. The multilayer inductor further includes a first extended conductor extended from a first end portion of the coil conductor and connected to the first terminal electrode and a second extended conductor extended from a second end portion of the coil conductor and connected to the second terminal electrode, the second end portion being positioned opposite to the first end portion. The first extended conductor includes a first outside via-conductor and a first inside via-conductor that penetrate through non-conductive layers in the thickness direction so as to extend parallel to each other while the first outside via-conductor and the first inside via-conductor are connected, in parallel, to each other and also connected to the first terminal electrode at the first end surface. The second extended conductor includes a second outside via-conductor and a second inside via-conductor that penetrate through non-conductive layers in the thickness direction so as to extend parallel to each other while the second outside via-conductor and the second inside via-conductor are connected, in parallel, to each other and also connected to the second terminal electrode at the second end surface. As the multilayer body is viewed through in the lamination direction of the non-conductive layers, all parts of the first outside via-conductor and of the second outside via-conductor are positioned so as to overlap the loop-segment conductors, and at least a part of the first inside via-conductor and at least a part of the second inside via-conductor are positioned inside an inner periphery of the loop-segment conductors.

<2> In the multilayer inductor described in <1> above, as the multilayer body is viewed through in the lamination direction of the non-conductive layers, all parts of the first inside via-conductor and of the second inside via-conductor are positioned inside the inner periphery of the loop-segment conductors.

<3> In the multilayer inductor described in <1> or <2> above, a cross-sectional area of the first inside via-conductor is greater than a cross-sectional area of the first outside via-conductor, and a cross-sectional area of the second inside via-conductor is greater than a cross-sectional area of the second outside via-conductor.

<4> In the multilayer inductor described any one of <1> to <3> above, the first outside via-conductor, the first inside via-conductor, the second outside via-conductor, and the second inside via-conductor extend so as to penetrate through multiple ones of the non-conductive layers in the thickness direction. The multilayer inductor further includes first outside land-conductors extending from the first outside via-conductor on respective interfaces between the adjacent ones of the non-conductive layers, first inside land-conductors extending from the first inside via-conductor on respective interfaces between the adjacent ones of the non-conductive layers, second outside land-conductors extending from the second outside via-conductor on respective interfaces between the adjacent ones of the non-conductive layers, and second inside land-conductors extending from the second inside via-conductor on respective interfaces between the adjacent ones of the non-conductive layers.

<5> In the multilayer inductor described in <4>, each one of the first outside land-conductors and a corresponding one of the first inside land-conductors are formed integrally, and each one of the second outside land-conductors and a corresponding one of the second inside land-conductors are formed integrally.

<6> In the multilayer inductor described in <5> above, an outline of the first outside land-conductor and the corresponding first inside land-conductor formed integrally is shaped such that an imaginary first outside circle having a center positioned at the first outside via-conductor partially superposes an imaginary first inside circle having a center positioned at the first inside via-conductor, and an outline of the second outside land-conductor and the corresponding second inside land-conductor formed integrally is shaped such that an imaginary second outside circle having a center positioned at the second outside via-conductor partially superposes an imaginary second inside circle having a center positioned at the second inside via-conductor.

<7> In the multilayer inductor described in <6> above, the imaginary first inside circle is smaller than the imaginary first outside circle, and the imaginary second inside circle is smaller than the imaginary second outside circle.

<8> In the multilayer inductor described in any one of <1> to <7> above, the first inside via-conductor is distributed into multiple locations, and the second inside via-conductor is also distributed into multiple locations.

<9> In the multilayer inductor described any one of <1> to <8> above, as the multilayer body is viewed through in the lamination direction of the non-conductive layers, the loop-segment conductors have an arbitrary number of corner portions, and the first outside via-conductor and the second outside via-conductor are positioned so as to overlap any one of the corner portions.

What is claimed is:

1. A multilayer inductor comprising:
a multilayer body including multiple non-conductive layers laminated in a lamination direction,
the multilayer body being a quadrangular prism shape or a substantially quadrangular prism shape that has a first end surface and a second end surface opposing each other and has four side surfaces connecting the first end surface and the second end surface to each other, and
the lamination direction extending parallel to a direction in which the first end surface and the second end surface face oppose each other;
a first terminal electrode provided on at least a portion of the first end surface and extending over a portion of at least one of the side surfaces adjacent to the first end surface;
a second terminal electrode provided on at least a portion of the second end surface and extending over a portion of at least one of the side surfaces adjacent to the second end surface;
a coil conductor inside the multilayer body,
the coil conductor including a plurality of loop-segment conductors that extend on interfaces between adjacent ones of the non-conductive layers and are configured as circular segments of the coil conductor,
the coil conductor including a plurality of intermediate via-conductors each of which penetrate through a non-conductive layer in a thickness direction thereof,
the plurality of the loop-segment conductors being connected to one another by respective ones of the intermediate via-conductors such that the coil conductor extends along a spiral line;
a first extended conductor extended from a first end portion of the coil conductor and connected to the first terminal electrode; and
a second extended conductor extended from a second end portion of the coil conductor and connected to the second terminal electrode, the second end portion being positioned opposite to the first end portion,
wherein
the first extended conductor includes a first outside via-conductor and a first inside via-conductor that penetrate through non-conductive layers in the thickness direction to extend parallel to each other while the first outside via-conductor and the first inside via-conductor are connected in parallel to each other and are connected to the first terminal electrode at the first end surface,
the second extended conductor includes a second outside via-conductor and a second inside via-conductor that penetrate through non-conductive layers in the thickness direction to extend parallel to each other while the second outside via-conductor and the second inside via-conductor are connected in parallel to each other and are connected to the second terminal electrode at the second end surface, and
as the multilayer body is viewed through in the lamination direction of the non-conductive layers, all portions of the first outside via-conductor and of the second outside via-conductor overlap the loop-segment conductors, and at least a portion of the first inside via-conductor and at least a portion of the second inside via-conductor are inside an inner periphery of the loop-segment conductors.

2. The multilayer inductor according to claim 1, wherein
as the multilayer body is viewed through in the lamination direction of the non-conductive layers, all portions of the first inside via-conductor and of the second inside via-conductor are inside the inner periphery of the loop-segment conductors.

3. The multilayer inductor according to claim 1, wherein
a cross-sectional area of the first inside via-conductor is greater than a cross-sectional area of the first outside via-conductor, and a cross-sectional area of the second inside via-conductor is greater than a cross-sectional area of the second outside via-conductor.

4. The multilayer inductor according to claim 1, wherein
the first outside via-conductor, the first inside via-conductor, the second outside via-conductor, and the second inside via-conductor extend to penetrate through multiple ones of the non-conductive layers in the thickness direction,
wherein the multilayer inductor further comprises:
first outside land-conductors extending from the first outside via-conductor on respective interfaces between the adjacent ones of the non-conductive layers,
first inside land-conductors extending from the first inside via-conductor on respective interfaces between the adjacent ones of the non-conductive layers,
second outside land-conductors extending from the second outside via-conductor on respective interfaces between the adjacent ones of the non-conductive layers, and
second inside land-conductors extending from the second inside via-conductor on respective interfaces between the adjacent ones of the non-conductive layers.

5. The multilayer inductor according to claim 4, wherein
each one of the first outside land-conductors and a corresponding one of the first inside land-conductors are configured integrally, and each one of the second outside land-conductors and a corresponding one of the second inside land-conductors are configured integrally.

6. The multilayer inductor according to claim 5, wherein
an outline of the first outside land-conductor and the corresponding first inside land-conductor configured integrally is shaped such that an imaginary first outside circle having a center positioned at the first outside via-conductor partially superposes an imaginary first inside circle having a center positioned at the first inside via-conductor, and
wherein an outline of the second outside land-conductor and the corresponding second inside land-conductor configured integrally is shaped such that an imaginary second outside circle having a center positioned at the second outside via-conductor partially superposes an imaginary second inside circle having a center positioned at the second inside via-conductor.

7. The multilayer inductor according to claim 6, wherein
the imaginary first inside circle is smaller than the imaginary first outside circle, and the imaginary second inside circle is smaller than the imaginary second outside circle.

8. The multilayer inductor according to claim 1, wherein
the first inside via-conductor is in multiple locations, and the second inside via-conductor is in multiple locations.

9. The multilayer inductor according to claim 1, wherein
as the multilayer body is viewed through in the lamination direction of the non-conductive layers, the loop-segment conductors have an arbitrary number of corner portions, and the first outside via-conductor and the second outside via-conductor overlap any one of the corner portions.
